(19) United States
(12) Patent Application Publication
(10) Pub. No.: US 2026/0331021 A1
(43) Pub. Date: Oct. 22, 2026

(54) ELECTRONIC SYSTEM, ADDRESS CONFIGURATION AND DATA TRANSMISSION METHOD, SLAVE DEVICE, AND ELECTRONIC APPARATUS

(71) Applicants: Beijing BOE Display Technology Co., Ltd., Beijing (CN); BOE TECHNOLOGY GROUP CO., LTD., Beijing (CN)

(72) Inventors: Lianghao ZHANG, Beijing (CN); Xin DUAN, Beijing (CN); Shuhuan YU, Beijing (CN); Wei SUN, Beijing (CN); Ying ZHOU, Beijing (CN)

(73) Assignees: Beijing BOE Display Technology Co., Ltd., Beijing (CN); BOE TECHNOLOGY GROUP CO., LTD., Beijing (CN)

(21) Appl. No.: 18/993,237

(22) PCT Filed: Mar. 1, 2023
(86) PCT No.: PCT/CN2023/079135

§ 371 Date: Jan. 10, 2025

(51) Int. Cl. G09G 3/20; G09G 3/32; G09G 3/34

(52) U.S. Cl. CPC G09G 3/2092; G09G 3/32; G09G 3/3406; G09G 2310/08; G09G 2370/10

(57) ABSTRACT

An electronic system, an address configuration and data transmission method, a slave device, and an electronic apparatus. The electronic system includes a master device, a plurality of slave devices, a clock signal line, and a first signal line; the master device is connected in parallel to the plurality of slave devices by a same clock signal line to provide a clock signal to the plurality of slave devices; a first slave device among the plurality of slave devices is connected to the master device by the first signal line, and the plurality of slave devices are sequentially connected in series by the first signal line. The electronic system can optionally select and control a slave device to transmit data with the master device.

### TECHNICAL FIELD

Embodiments of the present disclosure relate to an electronic system, an address configuration and a data transmission method, a slave device, and an electronic apparatus.

### BACKGROUND

In the field of display technology, for example, a light-emitting unit array of a light-emitting diode (LED) backlight plate of a liquid crystal display panel, and a pixel array of a light-emitting diode (LED) display panel (e.g., a mini-LED display panel), etc. usually include a plurality of rows and a plurality of columns of separately driven light-emitting elements (e.g., LEDs); for another example, a touch panel (e.g., a self-capacitive touch panel) usually includes a plurality of rows and a plurality of columns of separately driven and detected touch units. Driving the light-emitting elements and the touch units may be implemented respectively by a bound drive circuit, for example, an integrated circuit (IC); for example, with respect to the LED display panel, each driver IC is configured to control three LED devices respectively implementing three primary colors (e.g., RGB).

In the above-described driving circuit of the electronic apparatus of, for example, the backlight plate, the LED display panel, or the touch panel, a plurality of driver IC devices are arranged, for example, by means of a plurality of channels (e.g., each channel corresponding to one column); and the driver IC devices in each channel need to be connected with each other through a conductive wires to transmit data signals and control signals (e.g., a clock signal, a chip select signal, etc.). In order to implement high-speed data transmission, the above-described electronic apparatus usually needs to have a large number of pins, so that the driver IC device is electrically connected with a plurality of data transmission lines and signal transmission lines. Due to the large number of driver IC devices in the driving circuit, interconnection between driver IC devices may make connection conductive wires between the driver IC devices and wiring of a printed circuit board (PCB) complex and occupy a large space, resulting in an increase in volume, power consumption, and costs of the integrated driving circuit.

### SUMMARY

At least one embodiment of the present disclosure provides an electronic system, comprising a master device, a plurality of slave devices, a clock signal line, and a first signal line, the master device is connected in parallel with the plurality of slave devices through a same clock signal line to supply a clock signal to the plurality of slave devices; a first slave device among the plurality of slave devices is connected with the master device through the first signal line; and the plurality of slave devices are sequentially connected in series through the first signal line.

For example, in the electronic system provided by at least one embodiment of the present disclosure, the first signal line serves as a first data transmission line, and the first data transmission line is used for data transmission between the master device and the first slave device and among the plurality of slave devices.

For example, the electronic system provided by at least one embodiment of the present disclosure further comprises: a second signal line independent of the first signal line; the second signal line comprises a first data transmission line; and the plurality of slave devices are connected in parallel with the master device through the first data transmission line independent of the first signal line.

For example, in the electronic system provided by at least one embodiment of the present disclosure, the first data transmission line is used for data transmission between the master device and the plurality of slave devices.

For example, in the electronic system provided by at least one embodiment of the present disclosure, the second signal line further comprises: a second data transmission line; and the plurality of slave devices are connected in parallel with the master device respectively through the first data transmission line and the second data transmission line.

For example, in the electronic system provided by at least one embodiment of the present disclosure, the master device sends data to the plurality of slave devices through the first data transmission line; and the master device receives data from the plurality of slave devices through the second data transmission line.

For example, in the electronic system provided by at least one embodiment of the present disclosure, the plurality of slave devices receive a data transmission signal comprising a first data packet from the master device through the first data transmission line, to select a target slave device from the plurality of slave devices for data transmission with the master device according to the first data packet.

For example, in the electronic system provided by at least one embodiment of the present disclosure, the first data packet comprises an address bit for selecting a target slave device to perform data transmission with the master device.

For example, in the electronic system provided by at least one embodiment of the present disclosure, the first data packet further comprises a data bit for recording data to be written into the target slave device.

For example, in the electronic system provided by at least one embodiment of the present disclosure, the plurality of slave devices receive a control word from the master device through the first data transmission line, to determine a data transmission mode between the plurality of slave devices and the master device according to the control word.

For example, in the electronic system provided by at least one embodiment of the present disclosure, the control word comprises a read/write flag bit for selecting a direction of data transmission.

For example, in the electronic system provided by at least one embodiment of the present disclosure, the control word further comprises a data length extension bit, an address length extension bit, or a target slave device quantity extension bit.

For example, in the electronic system provided by at least one embodiment of the present disclosure, the first signal line is an address configuration line; the plurality of slave devices receive an address configuration signal from the master device through the address configuration line; and the address configuration signal is used for configuring an initial device address for the plurality of slave devices.

For example, in the electronic system provided by at least one embodiment of the present disclosure, the first signal line is multiplexed as an address configuration line; the plurality of slave devices receive an address configuration signal from the master device through the address configuration line; and the address configuration signal is used for configuring an initial device address for the plurality of slave devices.

For example, in the electronic system provided by at least one embodiment of the present disclosure, a last slave device among the plurality of slave devices is not directly connected with the master device through the first signal line.

At least one embodiment of the present disclosure provides a slave device for connection with a master device or connection in series with other slave devices, the slave device comprises a clock terminal, a first terminal, a second terminal, and an address storage module, the clock terminal is connected with the master device through a clock signal line to receive a clock signal from the master device; the first terminal is connected with the master device through an address configuration line, or connected with a second terminal of a previous adjacent slave device connected in series with the slave devices; the address storage module is configured to store a device address corresponding to the slave device.

For example, in the slave device provided by at least one embodiment of the present disclosure, the first signal line serves as the first data transmission line, and the first terminal of the slave device is connected with the master device through the first signal line serving as the first data transmission line, or is connected with the second terminal of the previous adjacent slave device connected in series with the slave devices through the first signal line serving as the first data transmission line.

For example, the slave device provided by at least one embodiment of the present disclosure further comprises a first data terminal configured to be connected with the master device through the first data transmission line.

For example, the slave device provided by at least one embodiment of the present disclosure further comprises a second data terminal configured to be connected with the master device through a second data transmission line, and the second data transmission line is different from the first data transmission line.

For example, in the slave device provided by at least one embodiment of the present disclosure, the slave device receives the device address from the master device through the first signal line.

For example, in the slave device provided by at least one embodiment of the present disclosure, after the slave device receives and configures the device address from the master device, the second terminal of the slave device is electrically coupled to a first terminal of a next adjacent slave device connected in series with the slave device through the first signal line, so that the next slave device starts and receives a device address corresponding to the next slave device from the master device.

For example, the slave device provided by at least one embodiment of the present disclosure, further comprises a control circuit configured to control the slave device configuring the device address or performing data transmission with the master device.

For example, in the slave device provided by at least one embodiment of the present disclosure, the control circuit comprises a switch control module and a data processing module coupled to each other; the switch control module is configured to control “ON” or “OFF” of the data processing module; and the data processing module is configured to process data received from the master device or data to be sent to the master device.

For example, in the slave device provided by at least one embodiment of the present disclosure, the switch control module comprises: a switch unit configured to control the first terminal being electrically connected with the address storage module so that the slave device is in the address configuration mode; and a counter unit configured to count the number of device addresses written into the address storage module in the address configuration mode, and electrically couple the second terminal of the slave device to a first terminal of a next adjacent slave device connected in series with the slave device through the first signal line in response to the number of device addresses counted.

For example, in the slave device provided by at least one embodiment of the present disclosure, the switch unit is further configured to control the first terminal being electrically connected with the data processing module, so that the slave device and the master device perform data transmission.

For example, in the slave device provided by at least one embodiment of the present disclosure, the switch control module is further configured to judge whether the slave device is a target slave device according to a match result between the device address of the address storage module and the first data packet; in response to the slave device being a target slave device, the switch control module controls the data processing module to turn on; and in response to the slave device being not a target slave device, the switch control module controls the data processing module to turn off, and transmits the first data packet to a next adjacent slave device connected in series with the slave device.

For example, in the slave device provided by at least one embodiment of the present disclosure, the address storage module comprises a read-only memory.

For example, in the slave device provided by at least one embodiment of the present disclosure, the data processing module comprises: a first register unit configured to store data received from the master device; and a first signal modulation unit connected with the first register unit, and configured to process data received from the master device.

For example, in the slave device provided by at least one embodiment of the present disclosure, the data processing module comprises: a sampling unit configured to acquire sampling data; and a second register unit connected with the sampling unit, and configured to store the sampling data to be sent to the master device.

For example, the slave device provided by at least one embodiment of the present disclosure further comprises a control terminal configured to be connected with a device to be controlled, wherein the device to be controlled comprises an LED or a touch unit.

For example, in the slave device provided by at least one embodiment of the present disclosure, the LED comprises at least one of a micro-LED and a mini-LED.

At least one embodiment of the present disclosure also provides an address configuring method of the electronic system, the first signal line is an address configuration line, and the method comprises: sequentially connecting a master device in series with a plurality of slave devices through an address configuration line; a first slave device among the plurality of slave devices being connected with the master device through the address configuration line; and the plurality of slave devices respectively receiving and configuring the plurality of device addresses corresponding to the plurality of slave devices from the master device.

For example, the address configuring method provided by at least one embodiment of the present disclosure further comprises: the master device sequentially assigning the plurality of device addresses to the plurality of slave devices through the address configuration line.

For example, in the address configuring method provided by at least one embodiment of the present disclosure, the sequentially connecting the master device in series with the plurality of slave devices through the address configuration line comprises: connecting a first terminal of the first slave device with the master device through the address configuration line; and electrically coupling a second terminal of each slave device among the plurality of slave devices to a first terminal of a next adjacent slave device connected in series with the each slave device through the address configuration line.

For example, in the address configuring method provided by at least one embodiment of the present disclosure, the connecting the master device in series with the plurality of slave devices through the address configuration line further comprises: suspending a second terminal of a last slave device among the plurality of slave devices.

For example, the address configuring method provided by at least one embodiment of the present disclosure further comprises: detecting whether an address storage module of the slave device is empty or not; in response to the address storage module of the slave device being empty, the slave device receiving a device address corresponding to the slave device from the master device and storing the device address assigned by the master device into the address storage module; and in response to completing the configuring the device address of the slave device, electrically coupling a second terminal of the slave device to a first terminal of a next adjacent slave device connected in series with the slave device through the address configuration line.

For example, the address configuring method provided by at least one embodiment of the present disclosure further comprises: detecting a level state of a first terminal of the slave device that is coupled with the address configuration line; in response to the first terminal of the slave device that is connected with the address configuration line being boosted, the slave device receiving and configuring the device address corresponding to the slave device from the master device; and in response to completing the configuring the device address of the slave device, electrically coupling a second terminal of the slave device to a first terminal of a next adjacent slave device connected in series with the slave device through the address configuration line.

At least one embodiment of the present disclosure also provides a data transmitting method of the electronic system, comprising: the plurality of slave devices receiving a first data packet from the master device; selecting a target slave device from the plurality of slave devices according to the first data packet; and implementing data transmission between the target slave device and the master device according to the first data packet.

For example, in the data transmitting method provided by at least one embodiment of the present disclosure, the first signal line serves as a first data transmission line, the plurality of slave devices receives the control word and the first data packet from the master device comprises: the plurality of slave devices receiving the first data packet from the master device through the first signal line multiplexed as the first data transmission line.

For example, in the data transmitting method provided by at least one embodiment of the present disclosure, the electronic system further comprises a first data transmission line independent of the first signal line; the plurality of slave devices are connected in parallel with the master device through the first data transmission line independent of the first signal line; the plurality of slave devices receiving the first data packet from the master device comprises the plurality of slave devices receiving the first data packet from the master device through the first data transmission line.

For example, in the data transmitting method provided by at least one embodiment of the present disclosure, the selecting the target slave device from the plurality of slave devices according to the first data packet comprises: acquiring an address bit in the first data packet; judging whether the device address of the slave device matches the address bit or not; in response to the device address of the slave device matching the address bit, selecting the slave device as the target slave device; and in response to the device address of the slave device not matching the address bit, judging whether a device address of a next adjacent slave device connected in series with the slave device matches the address bit, or not.

For example, the data transmitting method provided by at least one embodiment of the present disclosure further comprises the plurality of slave devices receiving a control word from the master device; and implementing data transmission between the target slave device and the master device according to the control word.

For example, in the data transmitting method provided by at least one embodiment of the present disclosure, the implementing data transmission between the target slave device and the master device according to the control word comprises: selecting a direction of data transmission according to a read/write flag bit in the control word; writing data recorded by the data bit in the first data packet into the target slave device through the first data transmission line, or sending a second data packet acquired from the target slave device to the master device through the first data transmission line.

For example, the data transmitting method provided by at least one embodiment of the present disclosure, the implementing data transmission between the target slave device and the master device according to the control word comprises: selecting a direction of data transmission according to a read/write flag bit in the control word; writing the data recorded by the data bit in the first data packet into the target slave device through the first data transmission line, or sending the second data packet acquired from the target slave device to the master device through the second data transmission line.

For example, the data transmitting method provided by at least one embodiment of the present disclosure the implementing data transmission between the target slave device and the master device according to the control word further comprises: selecting a length of the transmitted data according to a data length extension bit in the control word; or, selecting a length of the device address according to an address length extension bit in the control word; or, selecting the number of target slave devices according to a target slave device quantity extension bit in the control word.

For example, the data transmitting method provided by at least one embodiment of the present disclosure further comprises: setting a preset time interval for data transmission according to the number of the plurality of slave devices.

For example, the data transmitting method provided by at least one embodiment of the present disclosure further comprises: controlling data transmission according to the clock signal of the clock signal line; in response to the clock signal being a start clock signal, starting the data transmission at a start flag bit corresponding to the start clock signal; and in response to the clock signal being an ending clock signal, ending the data transmission at an ending flag bit corresponding to the ending clock signal.

At least one embodiment of the present disclosure also provides an electronic apparatus, comprising the electronic system according to any embodiment of the present disclosure.

### BRIEF DESCRIPTION OF DRAWINGS

In order to more clearly illustrate the technical solutions of the embodiments of the present disclosure, the drawings of the embodiments will be briefly introduced below. Apparently, the drawings in the following description only relate to some embodiments of the present disclosure, rather than limiting the present disclosure.

FIG. 1 is a schematic block diagram of an electronic system provided by at least one embodiment of the present disclosure;

FIG. 2 is a schematic block diagram of another electronic system provided by at least one embodiment of the present disclosure;

FIG. 3 is a schematic block diagram of still another electronic system provided by at least one embodiment of the present disclosure;

FIG. 4 is a schematic block diagram of a slave device provided by at least one embodiment of the present disclosure;

FIG. 5 is a schematic block diagram of a slave device provided by at least one embodiment of the present disclosure;

FIG. 6 is a schematic block diagram of another slave device provided by at least one embodiment of the present disclosure;

FIG. 7 is a schematic block diagram of still another slave device provided by at least one embodiment of the present disclosure;

FIG. 8 is a circuit structure diagram of an exemplary slave device provided by at least one embodiment of the present disclosure;

FIG. 9 is a circuit structure diagram of another exemplary slave device provided by at least one embodiment of the present disclosure;

FIG. 10 is a flow chart of an address configuring method of an electronic system provided by at least one embodiment of the present disclosure;

FIG. 11 is a flow chart of a data transmitting method of an electronic system provided by at least one embodiment of the present disclosure;

FIG. 12 is a timing diagram of data transmission of an electronic system provided by at least one embodiment of the present disclosure;

FIG. 13 is a schematic diagram of an electronic apparatus provided by at least one embodiment of the present disclosure;

FIG. 14 is a schematic diagram of an electronic system of an electronic apparatus provided by at least one embodiment of the present disclosure; and

FIG. 15 is a schematic diagram of another electronic system of an electronic apparatus provided by at least one embodiment of the present disclosure.

### DETAILED DESCRIPTION

To make the objective, technical solutions, and advantages of the embodiments of the present application more clearly, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any creative work, which should be within the scope of the disclosure.

Unless otherwise defined, all the technical and scientific terms used herein have the same meanings as commonly understood by one of ordinary skill in the art to which the present disclosure belongs. The terms, such as ‘first,’ ‘second,’ or the like, which are used in the present disclosure, are not intended to indicate any sequence, amount or importance, but for distinguishing various components. The terms, such as ‘comprise/comprising,’ ‘include/including,’ or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not limited to a physical connection or mechanical connection, but may include an electrical connection/coupling, directly or indirectly. The terms, ‘on,’ ‘under,’ ‘left,’ ‘right,’ or the like are only used to indicate relative position relationship, and when the absolute position of the object which is described is changed, the relative position relationship may be changed accordingly.

Below are several specific embodiments to illustrate the present disclosure. In order to make clarity and conciseness of the following description of the disclosed embodiments, detailed explanations of known functions and known components may be omitted. When any part (element) of the embodiments of the present disclosure appears in more than one drawing, the part (element) is represented by the same or similar reference numeral in each drawing.

In an integrated driving circuit of an electronic apparatus of, for example, a backlight plate or an LED display panel, a serial peripheral interface (SPI) is a commonly used communicative connection mode for the driver IC. In an integrated driving circuit of an electronic apparatus of, for example, a touch panel, an inter-integrated circuit (IIC) is a commonly used communicative connection mode for the driver IC.

For example, in an SPI protocol, devices may be classified as a master device and a slave device. The master device is a control device, for example, which may be a microcontroller (MCU). The master device will generate a corresponding clock signal according to data to be exchanged; and the clock signal may control data exchange between the master device and the slave device.

In an electronic system applicable to the SPI protocol, the slave device does not have a device address, and the slave device is in one-on-one connection with the master device through a chip select (CS) signal line; and the master device may select a slave device that needs data transmission through the chip select signal line. In addition to the chip select signal line, a clock (SCLK) signal line, a master device output slave device input (MOSI) signal line, and a master device input slave device output (MISO) signal line are also connected between the master device and the slave device. Through the MISO signal line and the MOSI signal line, SPI may simultaneously send and receive data, so as to implement high-speed data transmission; a data transmission speed of SPI may reach, for example, 10 megabits per second (Mbps). However, SPI usually requires use of four wires, and for an electronic system having a plurality of slave devices, a large number of connection wires between devices will occupy a larger area, leading to an increase in volume of the integrated circuit.

For example, in the IIC protocol, although multi-device control may be implemented through two wires, yet usually only up to 8 driven devices (e.g., driver IC devices) may be mounted in each channel, and a transmission speed in the IIC protocol may only reach up to 3.4 Mbps.

At least one embodiment of the present disclosure provides an electronic system. The electronic system includes a master device, a plurality of slave devices, a clock signal line, and a first signal line. The master device is connected in parallel with the plurality of slave devices through a same clock signal line to supply a clock signal to the plurality of slave devices; a first slave device among the plurality of slave devices is connected with the master device through a first signal line, and the plurality of slave devices are sequentially connected in series through the first signal line.

The electronic system according to the above-described embodiment of the present disclosure has the plurality of slave devices sequentially connected in series through the first signal line, which may reduce the number of signal lines connecting between the master device and the slave devices, and thus has advantages, such as simplified wiring, fast data transmission speed, and a large number of slave devices that may be mounted, so that addressing may be performed according to a device address of a slave device, and a slave device may be arbitrarily selected and controlled for data transmission with the master device.

In a specific embodiment, the first signal line is divided into a plurality of segments, the first slave device is connected with the master device through a first segment of the first signal line; and the plurality of slave devices are sequentially connected in series through other segments of the first signal line. For example, the first slave device may be directly connected with the master device through the first segment of the first signal line.

At least one embodiment of the present disclosure also provides a slave device; and the slave device is used for connection with the master device or connection in series with other slave devices. The slave device includes a clock terminal, a first terminal, a second terminal, and an address storage module; the clock terminal is connected with the master device through a clock signal line to receive a clock signal from the master device; the first terminal is connected with the master device through a first signal line, or connected with a second terminal of a previous adjacent slave device connected in series with the slave device; and the address storage module is configured to store a device address corresponding to the slave device.

The slave device according to the above-described embodiment of the present disclosure has advantages, such as simplified structure, few pins, and strong adaptability, and is applicable to an electronic system provided by at least one embodiment of the present disclosure; and the slave device has an address storage module, which may store a device address and implement efficient data transmission with the master device according to the device address.

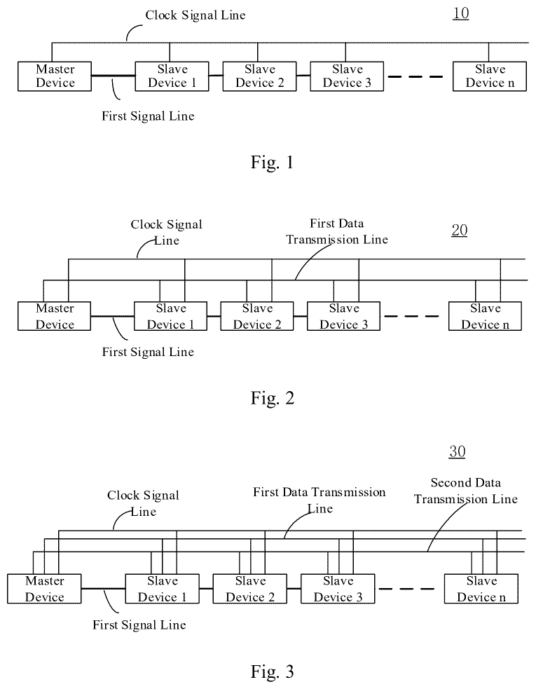

FIG. 1 shows an electronic system 10 provided by at least one embodiment of the present disclosure. As shown in FIG. 1, the electronic system 10 includes a master device, a plurality of slave devices (slave device 1 to slave device n), a clock signal line, and a first signal line.

In at least one embodiment of the present disclosure, the master device may be a control device, having functions, such as supplying a clock signal, assigning an address to a slave device, and initiating communication, for example, which may be implemented by an integrated circuit, and for example, the master device includes a microcontroller (MCU). Structure and type of the master device will not be limited in the embodiments of the present disclosure.

For example, a plurality of slave devices may be provided. For example, one electronic system may mount n slave devices sequentially connected in series in each channel of the master device, where n is an integer greater than 1; for example, one master device may be connected with 4, 6, 8, or 64 slave devices in each channel, and each master device may mount one or more channels. For example, the plurality of slave devices may be the same or different. For example, the slave device may be a driver IC used in a backlight (e.g., an LED) on a backlight plate of an liquid crystal display panel, for example, the slave device may be used in a backlight plate with LEDs (e.g., mini-LEDs, micro-LEDs, etc.) arranged with small separation distances; the slave device may also be a driver IC used in a touch unit in a touch panel, for example, the touch panel is used in a touch screen; the slave device may also be used in other fields, for example, photosensitive detection, etc., which will not be limited in the embodiments of the present disclosure. The slave device may be implemented, for example, through an integrated circuit, and structure and type of the slave devices will not be limited in the embodiments of the present disclosure.

As shown in FIG. 1, the master device is connected in parallel with a plurality of slave devices through a same clock signal line to supply a clock signal to the plurality of slave devices. For example, the clock signal line is led out from a clock port (not shown) of the master device, connected in parallel to a clock terminal of each slave device (not shown), and led into the each slave device, and slave device 1, slave device 2, slave device 3 . . . , and slave device n, may receive clock signal from the master device through the clock signal line.

It is to be noted that in the description of the embodiment of the present disclosure, that the master device is connected in parallel with a plurality of slave devices through a same clock signal line may be understood as that the master device is in head-to-head connection with any one slave device among the plurality of slave devices through the clock signal line, and is in “tail-to-tail” connection through other signal line in the electronic system, and the other signal line may be, for example, a ground (GND) line. For example, in the embodiment shown in FIG. 1, the clock port of the master device is respectively connected with clock terminals of slave device 1, slave device 2, slave device 3 . . . , and slave device n through the clock signal line, and a ground terminal of the master device is respectively connected with ground terminals of slave device 1, slave device 2, slave device 3 . . . , and slave device n through a GND line (not shown). The following respective embodiments are same as above embodiments, which will not be repeated here.

For example, a first slave device among the plurality of slave devices is connected with the master device through the first signal line; and the plurality of slave devices are sequentially connected in series through the first signal line. For example, the first signal line is led out from the master device and coupled to a first terminal of slave device 1 (not shown); a second terminal of slave device 1 may be electrically coupled to a first terminal of slave device 2 through the first signal line; a second terminal of slave device 2 may be electrically coupled to a first terminal of slave device 3 through the first signal line, and sequentially connected in series to a first terminal of a last slave device (e.g., slave device n). That is to say, the plurality of slave devices may be connected in series through a first signal line, thereby reducing overall wiring in the driving circuit and making wiring of the driving circuit simpler and more convenient.

For example, in at least one embodiment of the present disclosure, the last slave device among the plurality of slave devices is not directly connected with the master device through the first signal line. That is, among the plurality of slave devices connected in series through the first signal line, a second terminal of the last slave device may be suspended and not directly connected with the master device, without forming a loop through the first signal line.

In the electronic system 10 shown in FIG. 1, the first signal line serves as a first data transmission line; the first slave device among the plurality of slave devices is connected with the master device through the first signal line serving as the first data transmission line; and the plurality of slave devices are sequentially connected in series through the first signal line. The first data transmission line is used for data transmission between the master device and the first slave device, and among the plurality of slave devices.

For example, in the electronic system 10, the first signal line may be used for transmitting data, implementing data transmission between the master device and the first slave device, and implementing data transmission between the master device and a plurality of other slave devices. Slave device 1, slave device 2, slave device 3 . . . , and slave device n may perform data transmission with the master device through the first data transmission line (the first signal line), for example, the plurality of slave devices may receive data from the master device through the first data transmission line, or the plurality of slave devices may send data to the master device through the first data transmission line.

For example, in at least one embodiment of the present disclosure, the first signal line may be multiplexed as an address configuration line to assign a slave device having no initial device address with a device address belonging to the slave device. For example, the first signal line is an address configuration line; the plurality of slave devices receive an address configuration signal from the master device through the address configuration line; and the address configuration signal is used for configuring initial device addresses for the plurality of slave devices. For example, the master device is configured to sequentially assign a plurality of device addresses to the plurality of slave devices through the address configuration line; and the plurality of slave devices are configured to respectively receive and configure a plurality of device addresses corresponding to the plurality of slave devices from the master device. The encoding mode of the device addresses will not be limited in the embodiments of the present disclosure.

For example, the master device may assign device address 1 to slave device 1 through an address configuration line; after slave device 1 receives device address 1 from the master device, slave device 1 writes device address 1 into an address storage module of slave device 1 to complete address configuration of slave device 1; then, slave device 2 is electrically connected with the address configuration line; the master device assigns device address 2 to slave device 2 through the address configuration line; after receiving device address 2 from the master device, slave device 2 writes device address 2 into an address storage module of slave device 2 to complete address configuration of slave device 2; then, slave device 3 is electrically connected with the address configuration line, and so on, until slave device n is electrically connected with the address configuration line; the master device assigns device address n to slave device n through the address configuration line; and slave device n receives and configures device address n of slave device n from the master device.

In the electronic system provided by at least one embodiment of the present disclosure, the plurality of slave devices may be assigned with corresponding address flags (e.g., device addresses) through the above-described address configuration process, so as to facilitate the master device to arbitrarily select and control a slave device during a subsequent data transmission process through the address flag, to achieve efficient and fast data transmission.

For example, in the display driving field, since a plurality of driver chips (a plurality of slave devices) produced in a same batch are usually not set with corresponding address flags inside when leaving factory, after the driver chips are installed and cascaded, the master device is incapable of independently controlling a given driver chip at the beginning. Moreover, since the driver chips also need to be mounted on the screen after the production, if there are already corresponding address flags inside the driver chips in an initial state when leaving factory, when mounting the driver chips according to the mounting positions on the circuit board, a large number of driver chips need to be installed in one-to-one correspondence with specific mounting positions, which will undoubtedly greatly increase difficulties in mounting.

In this regard, in the electronic system provided by at least one embodiment of the present disclosure, the above-described address configuration process may be chosen to be perform after the production of the display panel is completed, that is, the above-described address configuration process may be carried out after the mounting is completed. For example, before the plurality of slave devices are electrically connected through the address configuration line, the plurality of slave devices may not have corresponding address flags set inside, for example, the plurality of slave devices may be a plurality of newly produced driver chips of a same specification, or a plurality of driver chips after the mounting is completed. After the mounting is completed, the plurality of slave devices are sequentially electrically connected through the address configuration line, to configure initial device addresses for the plurality of driver chips (the plurality of slave devices) through the above-described address configuration process; and thereafter, the master device is allowed to independently control a given driver chip among the plurality of cascaded driver chips, which may reduce difficulty in mounting the driver chips and improve flexibility of address configuration.

For example, in one example, the above-described address configuration process may be performed only once, to assign unique device addresses to the plurality of slave devices. For example, in the above-described display driving application scenario, the address configuration may be performed once on the plurality of slave devices after the mounting is completed; and after the product leaves the factory, for example, during actual use of the product, it is no longer needed to perform the address configuration on the slave devices, which can simplify the procedure, save startup time of the product, and reduce system power consumption and costs of use.

For example, in another example, the above-described address configuration process may also be performed multiple times, to flexibly adjust the device addresses of the plurality of slave devices according to changes in actual needs. For example, when one or more slave devices need to be replaced or removed, or when address configuration failure or configuration error of some slave device is detected, an address reset operation may be performed on the slave device in the electronic system, to clear the address stored in the address storage module of the slave device; or electrical connection of the address configuration line between the plurality of slave devices is disconnected, to configure the device address for the slave device again, which may improve accuracy of address configuration, and make the electronic system suitable for more flexible application scenarios.

In summary, in the electronic system provided by at least one embodiment of the present disclosure, it is not necessary to rely on a slave device already having a unique device address; instead, the master device may automatically assign a plurality of device addresses to a plurality of slave devices through an address configuration line, supplying address flags for data transmission between the master device and the plurality of slave devices, which facilitates fast addressing by the master device, so that the master device is capable of arbitrarily selecting and controlling the slave device for data transmission with the master device, thereby improving data transmission efficiency.

For example, in at least one embodiment of the present disclosure, the plurality of slave devices of the electronic system may be in an address configuration mode or a data transmission mode. In the address configuration mode, the plurality of slave devices sequentially receive and configure a plurality of device addresses corresponding to the plurality of slave devices from the master device. In the data transmission mode, the plurality of slave devices receive a data transmission signal from the master device through a first data transmission line; the data transmission signal includes, for example, a control word and a first data packet, to select a target slave device from the plurality of slave devices for data transmission with the master device according to the first data packet. For example, the address configuration mode may be enabled before the product leaves the factory and disabled after the product leaves the factory, so that the product keeps in the data transmission mode after leaving the factory, allowing for efficient data transmission. However, this does not serve as a limitation to the present disclosure.

Specifically, when the plurality of slave devices are in the data transmission mode, the plurality of slave devices receive a control word and a first data packets from the master device through the first signal line serving as the first data transmission line, to implement data transmission with the master device. When the plurality of slave devices are in the address configuration mode, for example, the plurality of slave devices sequentially receive information of a plurality of device addresses from the master device through the first signal line multiplexed as an address configuration line, and configure a plurality of device addresses corresponding to the plurality of slave devices.

In the above-described embodiments, the electronic system 10 may implement data transmission between the master device and the slave devices through two signal lines (i.e., a clock signal line and a first data transmission line). This not only simplifies the connection structure, but also greatly saves the wiring quantity. When the electronic system according to the above-described embodiments is used in the display field, for example, used in a mini-LED display panel, it may save wiring space on the lower frame of the display screen, reduce volume of the display driving circuit, reduce difficulty in layout and wiring, and save design costs.

Although the above-described electronic system 10 only requires two signal lines to implement data transmission, yet in some cases, for example, when there are a large number of slave devices connected in series through the first signal line, if each slave device has relatively large parasitic capacitance and parasitic resistance inside, it may lead to signal transmission delay, which may result in signal asynchronous problems, further leading to data loss or misalignment.

With respect to the above-described problems, at least one embodiment of the present disclosure can control the quantity of slave devices mounted on electronic system 10, or consider that parasitic capacitance and parasitic resistance inside the slave device are sufficiently small during the actual layout and wiring process.

With respect to the above-described problems, at least one embodiment of the present disclosure also provides an electronic system 20; the electronic system 20 has three signal lines. As compared with the electronic system 10 according to the embodiment of FIG. 1, the electronic system 20 shown in FIG. 2, in addition to the clock signal line and the first signal line, further includes a second signal line independent of the first signal line; and the second signal line includes a first data transmission line.

For example, in the embodiment shown in FIG. 2, the second signal line is the first data transmission line; a plurality of slave devices are connected in parallel with the master device through the first data transmission line independent of the first signal line; and the first data transmission line is used for data transmission between the master device and the plurality of slave devices.

It is to be noted that, that the plurality of slave devices are connected in parallel with the master device through the first data transmission line independent of the first signal line may be understood as that any one slave device among the plurality of slave devices is in “head-to-head connection” with the master device through the first data transmission line, and is in “tail-to-tail” connection with the master device through other signal line in the electronic system, and the other signal line, for example, may be a ground (GND) line. For example, in the embodiment shown in FIG. 2, the master device is respectively connected with first data terminals (e.g., first data terminals 609 as shown in FIG. 6) of slave device 1, slave device 2, slave device 3 . . . , and slave device n through a first data transmission line, and a ground terminal of the master device is respectively connected with ground terminals (not shown) of slave device 1, slave device 2, slave device 3 . . . , and slave device n through a GND line. For example, in the electronic system 20, the first signal line may be used for assigning addresses, and the first data transmission line may be used for transmitting data. For example, the first data transmission line is led out from the master device and coupled in parallel to a data terminal of each slave device, such as the first data terminal according to the present disclosure. Slave device 1, slave device 2, slave device 3 . . . , and slave device n may perform data transmission with the master device through the first data transmission line, for example, the plurality of slave devices may receive data from the master device through the first data transmission line, or the plurality of slave devices may send data to the master device through the first data transmission line.

Specifically, when the plurality of slave devices are in the address configuration mode, the plurality of slave devices sequentially receive and configure a plurality of device addresses corresponding to the plurality of slave devices from the master device through the first signal line; and when the plurality of slave devices are in the data transmission mode, the plurality of slave devices receive a control word and a first data packet from the master device through the first data transmission line, to implement data transmission with the master device.

In this embodiment, the electronic system 20 may use three signal lines to implement data transmission between the master device and the slave device. By separating the first data transmission line from the first signal line and connecting the plurality of slave devices in parallel through the first data transmission line, the signal transmission delay problem caused by parasitic resistance and parasitic capacitance may be effectively prevented, which can improve reliability of data transmission. Meanwhile, the electronic system 20 has a relatively simple structure, which may save the wiring quantity and mount more slave devices; when it is used in the display field, for example, it is used in a mini-LED display panel, the electronic system 20 may also save wiring space of the lower frame of the display screen, reduce volume of the driving circuit, reduce difficulty in layout wiring, and save design costs.

With respect to the electronic system 10 and the electronic system 20, the master device needs to have programmability to control any slave device and implement hierarchical data transmission; for example, the master device may include a programmable device, such as a microcontroller unit (MCU) or a field programmable gate array (FPGA). In other cases, the electronic system (e.g., some non-programmable devices (e.g., system on chip (SOC)) may not only be configured to implement the embodiments of the present disclosure, but may also be configured to be applicable to the SPI protocol, that is, compatible with the SPI protocol, which requires use of four signal lines for data transmission.

In this regard, at least one embodiment of the present disclosure also provides an electronic system 30; the electronic system 30 has four signal lines. As compared with the electronic system 10, the electronic system 30 shown in FIG. 3, in addition to the clock signal line and the first signal line, further includes two second signal lines independent of the first signal line, that is, a first data transmission line and a second data transmission line.

For example, in the electronic system 30, the first signal line may be used for assigning addresses; and the first data transmission line and the second data transmission line may be respectively used for the master device to send and receive data. For example, the first data transmission line is used for a plurality of slave devices to receive data from the master device; and the second data transmission line is used for the plurality of slave devices to send data to the master device. For example, the plurality of slave devices are connected in parallel with the master device respectively through the first data transmission line and the second data transmission line. For example, the first data transmission line and the second data transmission line are both led out from the master device; the first data transmission line is coupled in parallel to a first data terminal of each slave device; and the second data transmission line is coupled in parallel to a second data terminal of each slave device.

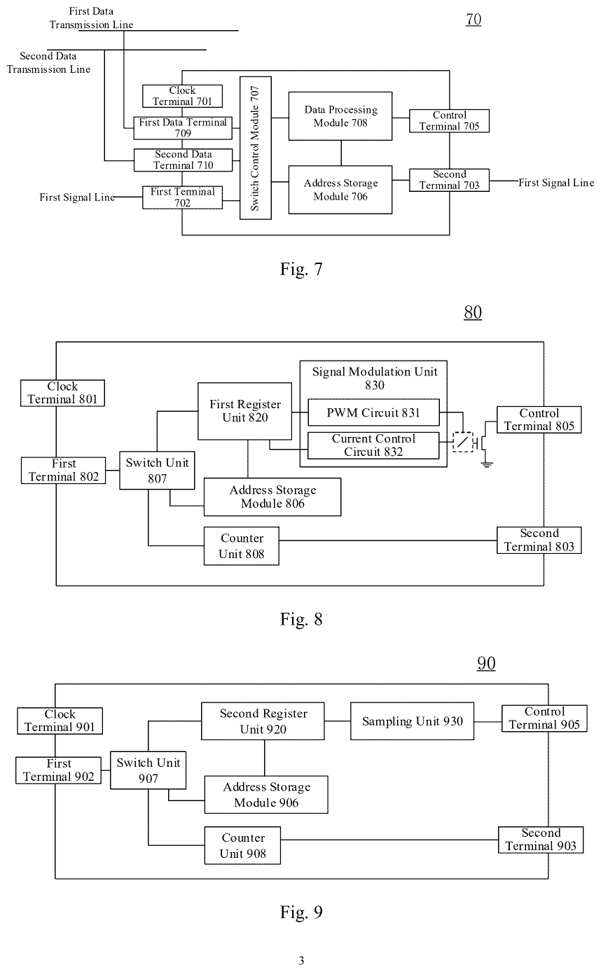

It is to be noted that the plurality of slave devices are connected in parallel with the master device respectively through the first data transmission line and the second data transmission line may be understood as that any one slave device among the plurality of slave devices is in “head-to-head connection” with the master device through the first data transmission line, and is in “tail-to-tail” connection with the master device through other signal line in the electronic system; any one slave device among the plurality of slave devices is in “head-to-head connection” with the master device through the second data transmission line, and is in “tail-to-tail” connection with the master device through other signal line in the electronic system; and other signal line may be a ground (GND) line. For example, in the embodiment shown in FIG. 3, the master device is respectively connected with first data terminals (first data terminals 709 shown in FIG. 7) of slave device 1, slave device 2, slave device 3 . . . , and slave device n through a first data transmission line, and the master device is respectively connected with second data terminals (second data terminals 710 shown in FIG. 7) of slave device 1, slave device 2, slave device 3 . . . , and slave device n through a second data transmission line; and a ground terminal of the master device is respectively connected with ground terminals (not shown) of slave device 1, slave device 2, slave device 3 . . . , and slave device n through a GND line.

Specifically, when the plurality of slave devices are in the address configuration mode, the plurality of slave devices sequentially receive information of a plurality of device addresses from the master device through the first signal line and configure the plurality of device addresses corresponding to the plurality of slave devices; and when the plurality of slave devices are in the data transmission mode, the plurality of slave devices receive a control word and a first data packet from the master device through the first data transmission line, and the plurality of slave devices send data to the master device through the second data transmission line.

For example, the electronic system 30 is a master device compatible with and applicable to the SPI protocol, and a plurality of chip select (CS) signal lines in the SPI protocol may be replaced with the first signal line according to the embodiment of the present disclosure. For example, the first data transmission line in the electronic system 30 may be a MOSI signal line in the SPI, and the second data transmission line may be a MISO data line in the SPI. For example, in the SPI protocol, the master device is connected with a plurality of slave devices through a plurality of chip select signal lines, while in the electronic system 30 according to the embodiment of the present disclosure, the master device is connected in series with the plurality of slave devices through a first signal line, which can reduce the wiring quantity, and can implement arbitrary control of the plurality of slave devices by the master device provided with the SPI protocol.

A communication protocol applicable to the above-described electronic system provided by at least one embodiment of the present disclosure will be illustrated below.

For example, in the above-described data transmission mode, the plurality of slave devices may receive a control word and a first data packet from the master device through the first data transmission line, to select a target slave device from the plurality of slave devices for data transmission with the master device according to the first data packet.

For example, in the electronic system provided by at least one embodiment of the present disclosure, the first data packet includes an address bit for selecting a target slave device to perform data transmission with the master device. For example, the address bit includes device addresses of one or more slave devices; after receiving the first data packet from the master device, each slave device may judge whether a device address thereof matches the address bit in the first data packet or not; if the device address matches one of addresses included in the address bit, it indicates that the slave device is the target slave device and can communicate with the master device through a data transmission line for data transmission; if the device address does not match any of the addresses included in the address bit, it indicates that the device is not the target slave device and cannot communicate with the master device, and thus data transmission cannot be performed, so that the first data packet needs to be transmitted to a next slave device connected in series.

For example, in the electronic system provided by at least one embodiment of the present disclosure, the first data packet further includes a data bit for recording data to be written into the target slave device. For example, after the address bit of the first data packet, there is a data bit that records, for example, M bytes of data sent by the master device to the target slave device, where M is a positive integer. The size of the transmitted data will not be limited in the embodiments of the present disclosure.

For example, in the electronic system provided by at least one embodiment of the present disclosure, the master device may transmit data to one slave device in one data transmission, or may transmit data to a plurality of slave devices in one data transmission.

For example, in one example, in one data transmission, the master device may arbitrarily select a slave device to send data to the slave device. For example, the first data packet sent by the master device contains one address and one piece of data, the address is a device address of a slave device, and the data is data sent to the slave device.

For example, in another example, in one data transmission, the master device may arbitrarily select a plurality of slave devices to send data to the plurality of slave devices, to improve a data transmission speed. For example, the master device may arbitrarily select eight adjacent slave devices from 64 slave devices, so as to transmit data to the eight adjacent slave devices in one data transmission. For example, the first data packet sent by the master device contains an address and 8 pieces of data, the address is a device address of a first slave device among the adjacent 8 slave devices, and the 8 pieces of data are pieces of data sequentially sent to the adjacent 8 slave devices. For example, when the first slave device receives a first piece of data in the first data packet, a second slave device may receive a second piece of data in the first data packet without performing an address matching operation, and so on, until the 8 slave devices receive all 8 pieces of data in the first data packet, to end this data transmission.

For example, in the electronic system provided by at least one embodiment of the present disclosure, the control word includes a read/write flag bit for selecting a direction of data transmission. For example, when the control word (or one bit of the control word) is 1, it indicates “write”, for example, which may be the master device sending data to the target slave device, that is, writing the data sent by the master device into the target slave device; when the control word (or one bit of the control word) is 0, it indicates “read”, for example, which may be the master device receiving data from the target slave device, that is, the master device reading data from the target slave device. For example, the control word is followed by an address bit.

For example, in the electronic system provided by at least one embodiment of the present disclosure, the control word includes a data length extension bit for selecting a length of transmitted data. For example, when the control word (or one bit of the control word) is 0, it indicates a data length of 8 bits; and when the control word (or one bit of the control word) is 1, it indicates a data length of 16 bits.

For example, in the electronic system provided by at least one embodiment of the present disclosure, the control word includes an address length extension bit for selecting a length of a transmission address. When the control word (or one bit of the control word) is 0, it indicates an address length of 8 bits; and when the control word (or one bit of the control word) is 1, it indicates an address length of 16 bits.

For example, in the electronic system provided by at least one embodiment of the present disclosure, the control word includes a target slave device quantity extension bit for selecting the number of target slave devices. For example, when the control word (or one bit of the control word) is 0, it indicates that the quantity of the target slave devices is 1, and the master device selects and controls one target slave device for data transmission, that is, the master device may control a single slave device. When the control word (or one bit of the control word) is 1, it indicates that the quantity of the target slave devices may be multiple, such as k target slave devices, where k is a positive integer, and the master device may select and control a plurality of target slave devices for data transmission, that is, the master device may control a plurality of slave devices to improve the data transmission speed.

For example, in the electronic system provided by at least one embodiment of the present disclosure, the control word may be an 8-bit control word. For example, a lowest bit of the control word may be a read/write flag bit, or may be other flag bit or extension bit. The control word may include one or more of the above-described flag bits and/or extension bits, for example, as required, a first bit of the control word may be set as a read/write flag bit, a second bit of the control word may be set as a data length extension bit, and a third bit of the control word may be set as an address length extension bit, and so on, which will not be limited in the embodiments of the present disclosure.

At least one embodiment of the present disclosure further provides architecture of a slave device. The slave device may be used for connection with the master device or connection in series with other slave devices, for example, the slave device may be used in the above-described electronic system, and the slave device may be any of the slave devices in the above-described electronic system.

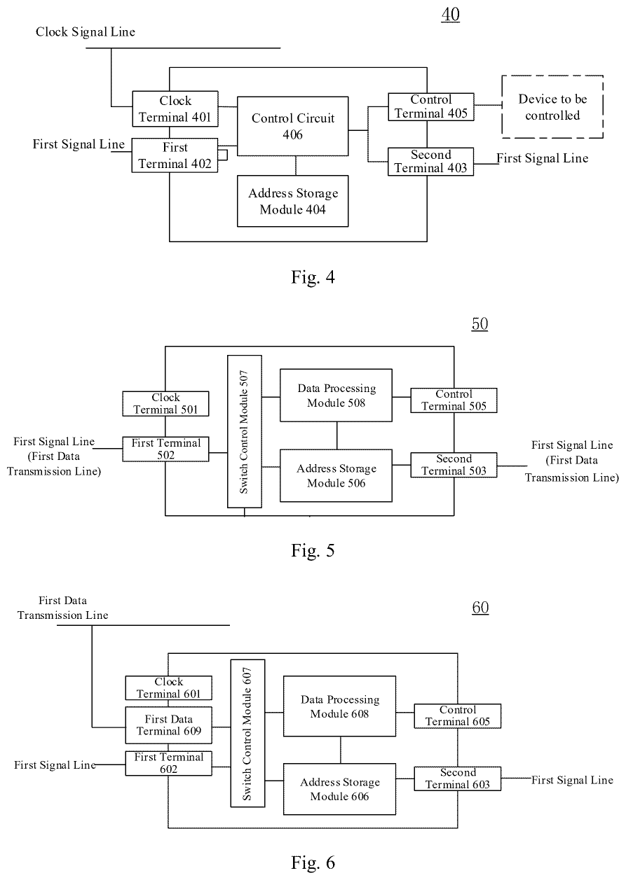

FIG. 4 is a schematic structure diagram of a slave device provided by at least one embodiment of the present disclosure. As shown in FIG. 4, a slave device 40 includes a clock terminal 401, a first terminal 402, a second terminal 403, and an address storage module 404.

For example, the clock terminal 401 of the slave device is connected with a master device through a clock signal line to receive a clock signal from the master device. For example, the clock terminal 401 of the slave device is connected with the clock signal line; the clock signal line is connected with a clock port of the master device; and the slave device may receive a clock signal from the master device through the clock signal line. The clock signal is used for supplying clock synchronization for the master device and a plurality of slave devices.

For example, the first terminal 402 of the slave device is connected with the master device through a first signal line, or is connected with a second terminal of a previous adjacent slave device connected in series with the slave device. For example, a second terminal 403 of the slave device 40 is connected with a first terminal 402 of a next adjacent slave device connected in series with the slave device through the first signal line or is suspended. For example, in one example, the electronic system includes a master device, and slave device 1, slave device 2, and slave device 3 sequentially connected through a first signal line; when the slave device 40 serves as a first slave device (slave device 1) in the electronic system of the example, a first terminal 402 of slave device 1 is coupled to the master device through a first signal line, and a second terminal 403 of slave device 1 is coupled in series to a first terminal 402 of slave device 2 through the first signal line; when the slave device 40 serves as a second slave device (slave device 2) in the electronic system of the example, a first terminal 402 of slave device 2 is coupled to a second terminal 403 of slave device 1 through a first signal line, and a second terminal 403 of slave device 2 is coupled in series to a first terminal 402 of slave device 3 through the first signal line; when the slave device 40 serves as a last slave device (slave device 3) in the electronic system of the example, a first terminal 402 of slave device 3 is coupled to a second terminal 403 of slave device 2 through a first signal line, and a second terminal 403 of slave device 3 is suspended.

For example, an address storage module 404 of the slave device is configured to store a device address corresponding to the slave device. The device address, for example, is a device address corresponding to the slave device assigned by the master device; for example, the slave device receives the device address from the master device through the first signal line. For example, in the above-described example, the master device may assign device address 1 to slave device 1 through a first signal line serving as an address configuration line; and after receiving device address 1 from the master device, slave device 1 writes device address 1 into the address storage module 404 of slave device 1 to complete address configuration of slave device 1. For example, after the slave device receives and configures the device address from the master device, a second terminal 403 of the slave device is electrically coupled to a first terminal 402 of a next adjacent slave device connected in series with the slave device through a first signal line, so that the next slave device starts and receives a device address corresponding to the next slave device from the master device. Here, the next slave device may be a slave device having a same structure as the slave device, that is, the next slave device also has a clock terminal, a first terminal 402, a second terminal 403, and an address storage module 404. For example, before the next slave device starts, a second terminal 403 of the slave device may be disconnected from a first terminal 402 of the next slave device; after the slave device completes configuring the device address, the second terminal 403 of the slave device is electrically connected with the first terminal 402 of the next slave device. For example, the electrical connection may be implemented by connecting the first terminal 402 and the second terminal 403 of the slave device inside the slave device, or may be implemented in other electrical connection mode, which will not be limited in the embodiments of the present disclosure.

For example, before address configuration, the address storage module 404 usually has no device address; after the next slave device starts, that is, after the next slave device is electrically connected with the slave device through the first signal line so as to be electrically connected with the master device, the next slave device may receive a device address corresponding to the next slave device from the master device. For example, in the above-described example, the first slave device (slave device 1) receives device address 1 corresponding to slave device 1 from the master device, which is 0000,0001; the next adjacent slave device connected in series with slave device 1 is slave device 2; after slave device 2 starts, slave device 2 may receive device address 2 corresponding to slave device 2 from the master device, which is 0000,0010, and so on, until all the slave devices acquire and configure their respective device addresses from the master device.

In the embodiment of the present disclosure, for example, the address storage module may include a volatile memory or a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory (Flash), a resistive random access memory (RRAM), a phase change memory (PCM), etc. The volatile memory may be a random access memory (RAM). By exemplary but not limitative illustration, many forms of RAM are available, for example, a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct rambus random access memory (DR RAM), which will not be limited in the embodiments of the present disclosure.

For example, in at least one embodiment of the present disclosure, as shown in FIG. 4, the slave device 40 further includes a control circuit 406 configured to control the slave device configuring a device address or performing data transmission with the master device. For example, the control circuit 406 may be configured to control the slave device being in an address configuration mode or a data transmission mode. In the address configuration mode, the slave device acquires the device address from the master device and writes the device address into the address storage module to complete address configuration. In the data transmission mode, data transmission is performed between the slave device and the master device, for example, the slave device receives data from the master device or sends data to the master device. For example, in at least one embodiment of the present disclosure, as shown in FIG. 4, the slave device 40 further includes a control terminal 405 configured to be connected with a device to be controlled. The control terminal 405 is electrically connected with the control circuit 406. For example, after the slave device receives data from the master device, the control circuit 406 of the slave device generates a control signal according to the data, and adjusts the device to be controlled through the control terminal 405. For example, when the device to be controlled is a mini-LED used in a backlight plate or a display panel, the slave device may control an ON/OFF state or brightness of the mini-LED in a backlight element or a pixel unit. For example, when the device to be controlled is a touch unit, the slave device may acquire a touch signal of the touch unit through the control terminal 405 and the control circuit 406, process the touch signal and store the touch signal as touch data, and then wait for data transmission with the master device, to send the touch data to the master device. For example, the device to be controlled may include a mini-LED or a touch unit, etc., which will not be limited in the embodiments of the present disclosure.

It is to be noted that in some embodiments of the present disclosure, the clock signal line is connected with a functional circuit inside the slave device through the clock terminal, so as to supply a synchronous clock signal to the functional circuit inside the slave device. The functional circuit includes a control circuit, a storage module, or other modules or units that rely on the clock signal, such as the address storage module, the control circuit, and a switch control module and a data processing module in the control circuit according to some embodiments of the present disclosure.

For example, as shown in FIG. 4, the control circuit 406 is connected with the clock terminal, so as to be connected with the clock signal line through the clock terminal 401, and receive a clock signal from the clock signal line for supplying clock synchronization between the master device and the slave device 40. For example, in the address configuration mode, the control circuit 406 acquires the device address from the master device according to the clock signal; and in the data transmission mode, the control circuit 406 performs data transmission with the master device according to the clock signal.

For example, in at least one embodiment of the present disclosure, the control circuit includes a switch control module and a data processing module coupled to each other; the switch control module is configured to control ON or OFF of the data processing module; and the data processing module is configured to process data received from the master device or data to be sent to the master device.

For example, in at least one embodiment of the present disclosure, as shown in FIG. 5, a slave device 50 includes a clock terminal 501, a first terminal 502, a second terminal 503, and an address storage module 506; the first terminal 502 and the second terminal 503 of the slave device 50 are both connected with a first signal line; and the first signal line may serve as a data transmission line. The relevant description of the ports, such as the clock terminal 401 and the control terminal 405 of the slave device 40 above, may be referred to for the structures and detailed description of the ports, such as the clock terminal 501 and the control terminal 505 of the slave device 50, and the repeated parts are not described again here. For example, in the embodiment shown in FIG. 5, the first signal line may serve as a first data transmission line to transmit data, or may serve as an address configuration line to assign a device address. That is, the first signal line may be multiplexed as an address configuration line to assign addresses to a plurality of slave devices. The first terminal of the slave device is connected with the master device through the first signal line serving as the first data transmission line, or is connected with a second terminal of a previous adjacent slave device connected in series with the slave device through the first signal line serving as the first data transmission line.

For example, as shown in FIG. 5, the control circuit of the slave device 50 includes a switch control module 507 and a data processing module 508; and the switch control module 507 is connected with the first terminal 502, the clock terminal 501, the data processing module 508, and the address storage module 506. For example, when the slave device 50 is in the address configuration mode, the switch control module 507 controls the first terminal 502 of the slave device 50 being electrically connected with the address storage module 506, so as to write the device address acquired by the slave device 50 from the master device through the first signal line into the address storage module 506; at this time, the data processing module 508 is turned off. When the slave device 50 is in the data transmission mode, the switch control module 507 controls the first terminal 502 of the slave device 50 being electrically connected with the data processing module 508, that is, turning on the data processing module 508, so that the slave device 50 may perform data transmission with the master device through the first data transmission line, for example, process data received from the master device (e.g., brightness adjustment data of the mini-LED) or process data to be sent to the master device (e.g., touch data). For example, the slave device 50 may be used in the electronic system 10 shown in FIG. 1. The slave device 50 has advantages, such as simple structure, fewer pins, and small volume; and the first signal line may serve as the first data transmission line and the address configuration line, so as to reduce the wiring of the electronic system.

For example, in at least one embodiment of the present disclosure, as shown in FIG. 6, a slave device 60 includes a clock terminal 601, a first terminal 602, a second terminal 603, and an address storage module 606; as compared with the slave device 50, the slave device 60 further includes a first data terminal 609, and the first data terminal 609 is configured to be connected with a master device through a first data transmission line. For example, the first terminal 602 and the second terminal 603 of the slave device 60 are both connected with a first signal line; the first data terminal 609 of the slave device 60 is connected with the first data transmission line; and the first data transmission line is independent of the first signal line. The relevant description of the ports, such as the clock terminal 401 and the control terminal 405 of the slave device 40 above, may be referred to for the structures and detailed description of the ports, such as the clock terminal 601 and the control terminal 605 of the slave device 60, and the repeated parts are not described again here.

For example, as shown in FIG. 6, the control circuit of the slave device 60 includes a switch control module 607 and a data processing module 608; and the switch control module 607 is connected with the first terminal 602, the first data terminal 609, the clock terminal 601, the data processing module 608, and the address storage module 606. For example, when the slave device 60 is in the address configuration mode, the switch control module 607 controls the first terminal 602 of the slave device 60 being electrically connected with the address storage module 606, so as to write a device address acquired from the master device through the first signal line into the address storage module 606; at this time, the data processing module 606 is turned off. When the slave device 60 is in the data transmission mode, the switch control module 607 controls the first data terminal 609 of the slave device 60 being electrically connected with the data processing module 608, that is, the data processing module 608 is turned on, so that the slave device 60 may perform data transmission with the master device through the first data transmission line, for example, process data received from the master device (e.g., brightness adjustment data of the mini-LED) or process data to be sent to the master device (e.g., touch data).

For example, the slave device 60 may be used in the electronic system 20 shown in FIG. 2. The slave device 60 has advantages, such as simple structure, fewer pins, and small volume; and the first data transmission line may be separated from the first signal line, which may effectively prevent signal transmission delay caused by the parasitic resistance and the parasitic capacitance inside the slave device, and may improve reliability of data transmission.

For example, in at least one embodiment of the present disclosure, as shown in FIG. 7, a slave device 70 includes a clock terminal 701, a first terminal 702, a second terminal 703, a first data terminal 709, and an address storage module 706; as compared with the slave device 60, the slave device 70 further includes a second data terminal 710 configured to be connected with the master device through a second data transmission line, and the second data transmission line is different from the first data transmission line. For example, the first terminal 702 and the second terminal 703 of the slave device 70 are both connected with a first signal line; the first data terminal 709 of the slave device 70 is connected with the first data transmission line; the second data terminal 710 of the slave device 70 is connected with the second data transmission line; and the first data transmission line and the second data transmission line are independent of the first signal line. The relevant description of the ports, such as the clock terminal 401 and control terminal 405 of the slave device 40 above, may be referred to the structures and detailed description of the ports, such as the clock terminal 701 and the control terminal 705 of the slave device 70, and the repeated parts are not described again here.

For example, as shown in FIG. 7, the control circuit of the slave device 70 includes a switch control module 707 and a data processing module 708; and the switch control module 707 is connected with the first terminal 702, the first data terminal 709, the second data terminal 710, the clock terminal 701, the data processing module 708, and the address storage module 706. For example, when the slave device 70 is in the address configuration mode, the switch control module 707 controls the first terminal of the slave device 70 being electrically connected with the address storage module 706, so as to write a device address of the slave device 70 acquired from the master device through the first signal line into the address storage module 706; at this time, the data processing module 708 is turned off. When the slave device 70 is in the data transmission mode, the switch control module 707 controls the first data terminal 709 or the second data terminal 710 of the slave device 70 being electrically connected with the data processing module 708, that is, the data processing module 708 is turned on, so that the slave device 70 may perform data transmission with the master device through a data transmission line. For example, the switch control module 707 may control the first data terminal 709 of the slave device being electrically connected with the data processing module 708, so that the slave device receives and processes data (e.g., brightness adjustment data of the mini-LED) from the master device through the first data transmission line, or the switch control module 707 may control the second data terminal of the slave device being electrically connected with the data processing module 708, so that the slave device 70 may send data (e.g., touch data) to the master device through the second data transmission line.

For example, the slave device 70 may be used in the electronic system 30 shown in FIG. 3. The slave device 70 has advantages, such as simple structure and strong adaptability, compatible with the SPI protocol to implement bidirectional data transmission, thereby improving data transmission efficiency.

It is to be noted that, in the above-described embodiments, the clock signal line of the slave device 50, the slave device 60, and the slave device 70 each is connected with at least one of the switch control module, the data processing module, and the address storage module inside the slave device through the clock terminal, so as to supply a synchronous clock signal to the functional circuits and the modules inside the slave device. For example, in the embodiment shown in FIG. 5, the switch control module 507, the data processing module 508, and the address storage module 506 in the control circuit are all connected with the clock terminal (not shown), so as to be connected with the clock signal line through the clock terminal 501, and receive the clock signal from the clock signal line for supplying clock synchronization to the master device and the slave device 50. For example, the switch control module 507 controls the slave device 50 switching to the address configuration mode according to the clock signal. For example, the slave device 50 acquires the device address from the master device according to the clock signal. For example, the address storage module 506 stores the device address acquired from the master device according to the clock signal. For example, the switch control module 507 controls the slave device 50 switching to the data transmission mode according to the clock signal. For example, the data processing module 508 performs data transmission with the master device according to the clock signal. In the embodiments shown in FIG. 6 and FIG. 7, as well as in the following various embodiments, a connection mode of the clock signal line with the various functional circuits inside the slave device may be the same as in the embodiment shown in FIG. 5, and no description will be repeated here.

For example, in at least one embodiment of the present disclosure, the switch control module includes a switch unit and a counter unit. The switch unit is configured to control the first terminal being electrically connected with the address storage module so that the slave device is in the address configuration mode; the counter unit is configured to count the number of device addresses written into the address storage module in the address configuration mode, and electrically couple the second terminal of the slave device to a first terminal of a next adjacent slave device connected in series with the slave device through the first signal line, in response to the number of device addresses counted.

For example, the counter unit is connected with the first terminal and the second terminal through the switch unit; the counter unit may be a counter used for counting the number of device addresses written into the address storage module of the slave device; when the counter counts to a given number of device addresses, the counter unit may electrically connect the first terminal and the second terminal of the slave device, so as to electrically connect the slave device with a next slave device adjacent to the slave device, for example, by connecting the second terminal of the slave device to the first terminal of the next slave device through the first signal line.

For example, in at least one embodiment of the present disclosure, the switch unit is further configured to control the first terminal being electrically connected with the data processing module, so that the slave device is in the data transmission mode to perform data transmission with the master device.

For example, the switch unit may further be configured to control the first data terminal and/or the second data terminal being electrically connected with the data processing module, so that the slave device receives and/or sends data. The relevant description of the embodiment of the switch control module above may be referred to for the detailed illustration of the data transmission process, and the repeated parts will not be described here.

For example, in at least one embodiment of the present disclosure, the switch control module is further configured to judge whether the slave device is a target slave device, or not according to a match result between the device address of the address storage module and the first data packet; in response to the slave device being a target slave device, the switch control module controls the data processing module to turn on; and in response to the slave device being not a target slave device, the switch control module controls the data processing module to turn off, and transmitting the first data packet to a next adjacent slave device connected in series with the slave device.

For example, when the slave device is connected in series with other slave device, the switch control module of the slave device may further judge whether the slave device is capable of performing data transmission with the master device, or not according to a match result between the device address of the slave device and the address bit in the first data packet (for addressing) sent by the master device; when the device address of the slave device matches the address bit of the target slave device required for data transmission, it is determined that the slave device is a target slave device, and the switch control module of the slave device may control the data processing module to turn on, to implement data transmission between the slave device and the master device. When the device address of the slave device does not match the address bit of the target slave device required for data transmission, it is determined that the slave device is not a target slave device, and the switch control module of the slave device may control the data processing module to turn off, and transmitting the first data packet to a next adjacent slave device connected in series with the slave device; and then continues to judge whether a device address of a next slave device matches the address bit, or not, and so on, until the target slave device is found, to complete the data transmission.

For example, in at least one embodiment of the present disclosure, the data processing module of the slave device includes a first register unit and a signal modulation unit. The first register unit is configured to store data received from the master device; and the signal modulation unit is connected with the first register unit, and is configured to process data received from the master device.

FIG. 8 is a circuit structure diagram of an exemplary slave device provided by at least one embodiment of the present disclosure. As shown in FIG. 8, a slave device 80 includes a clock terminal 801, a first terminal 802, a second terminal 803, a control terminal 805, an address storage module 806, and a switch control module (e.g., including a switch unit 807 and a counter unit 808). The relevant description above may be referred to for the structures and detailed description of these ports and modules, and the repeated parts will not described again here. For example, a data processing module of the slave device 80 includes a first register unit 820 and a signal modulation unit 830; and the first register unit 820 is connected with the signal modulation unit 830. For example, the first register unit 820 may include a current register and a pulse width modulation (PWM) register; and the signal modulation unit 830 may include a pulse width modulation unit circuit 831 and a current control circuit 832. For example, the current register may temporarily store current control data received; and the pulse width modulation register may temporarily store pulse width modulation data received and then transmit the pulse width modulation data to the signal modulation unit; for example, the signal modulation unit may further include an analog-to-digital converter (ADC) to convert a current control signal into an analog voltage, to control a device to be controlled.

For example, in one example of this embodiment, the slave device 80 is a backlight driver chip of a mini-LED; and the device to be controlled is a mini-LED (or a micro-LED). For example, the control terminal 805 of the slave device 80 is connected with a mini-LED lamp through a field effect transistor (a MOS transistor); for example, a source electrode of the MOS transistor is connected with the mini-LED lamp through the control terminal; and a gate electrode of the MOS transistor is connected with the signal modulation unit to control ON and OFF of the mini-LED lamp according to a magnitude of a gate voltage. For example, when the MOS transistor is turned on, the mini-LED lamp is turned on; and when the MOS transistor is turned off, the mini-LED lamp is turned off. For example, the MOS transistor may also adjust brightness of the mini-LED lamp according to brightness adjustment data (e.g., PWM data) of the mini-LED lamp received by the slave device 80 from the master device.

For example, in at least one embodiment of the present disclosure, the data processing module of the slave device includes a sampling unit and a second register unit. The sampling unit is configured to acquire sampling data; and the second register unit is connected with the sampling unit and is configured to store the sampling data to be sent to the master device.

FIG. 9 is a circuit structure diagram of an exemplary slave device provided by at least one embodiment of the present disclosure. As shown in FIG. 9, a slave device 90 includes a clock terminal 901, a first terminal 902, a second terminal 903, a control terminal 905, an address storage module 906, and a switch control module (e.g., including a switch unit 907 and a counter unit 908). The relevant description above may be referred to for the structures and detailed description of these ports and modules, and the repeated parts will be described again here. For example, a data processing module of the slave device 90 includes a sampling unit 930 and a second register unit 920; and the sampling unit 930 is connected with the second register unit 920. For example, the second register unit 920 may include a current register and a touch register; and the sampling unit 930 may include an amplifier and an analog-to-digital converter. For example, the sampling unit 930 may collect a signal from a device to be controlled and convert the collected signal into sampling data to temporarily store in the second register unit 920 to be sent to the master device.

For example, in one example of this embodiment, the slave device 90 is a driver chip of a touch unit; and the device to be controlled is the touch unit. For example, the control terminal 905 of the slave device 90 is connected with the touch unit, to collect a touch signal from the touch unit.

For example, in at least one embodiment of the present disclosure, the first register unit and the second register unit may further include a control signal register, for example, the control signal register is configured to temporarily store the control signal of the switch control module. The specific circuit structure of the control circuit of the slave device will not be limited in the embodiments of the present disclosure.

The slave device provided by at least one embodiment of the present disclosure has advantages, such as simple structure, few pins, and strong adaptability, and is applicable to the electronic system provided by at least one embodiment of the present disclosure; and the slave device has an address storage module, which may store a device address acquired from the master device through the first signal line, and implement efficient data transmission with the master device according to the device address.

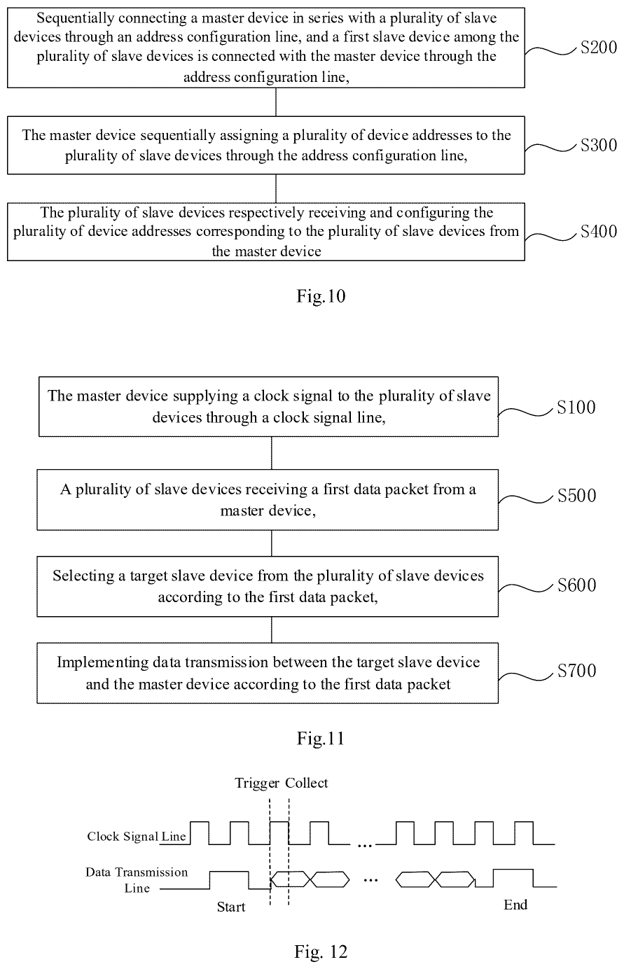

At least one embodiment of the present disclosure further provides an address configuring method of an electronic system. FIG. 10 shows a flow chart of an address configuring method of an electronic system provided by at least one embodiment of the present disclosure. For example, a first signal line in the electronic system is an address configuration line; and as shown in FIG. 10, the address configuring method includes step S200 to step S400.

Step S200: sequentially connecting a master device in series with a plurality of slave devices through an address configuration line, and a first slave device among the plurality of slave devices is connected with the master device through the address configuration line.

Step S300: the master device sequentially assigning a plurality of device addresses to the plurality of slave devices through the address configuration line.

Step S400: the plurality of slave devices respectively receiving and configuring the plurality of device addresses corresponding to the plurality of slave devices from the master device.

For example, the address configuring method may be used in the above-described electronic system 10, 20 or 30.

For example, the electronic system includes a master device, a plurality of slave devices, a clock signal line, and an address configuration line. For example, each slave device includes a first terminal, a second terminal, a clock terminal, and an address storage module. For example, the slave device may be any slave device of the above-described slave devices 40 to 90.

For example, in at least one example of the embodiment of the present disclosure, the address configuring method further includes: the master device sequentially assigning the plurality of device addresses to the plurality of slave devices through the address configuration line, for example, the master device sequentially assigns the plurality of device addresses to the plurality of slave devices in an order in which the plurality of slave devices are connected in series, however, the embodiment of the present disclosure is not limited to the “sequentially assigning”.

For example, in at least one example of the embodiment of the present disclosure, step S200: sequentially connecting the master device in series with the plurality of slave devices through an address configuration line, and a specific example including: connecting a first terminal of a first slave device with the master device through the address configuration line; and electrically coupling a second terminal of each slave device among the plurality of slave devices to a first terminal of a next adjacent slave device connected in series with the slave device through the address configuration line.

For example, in at least one example of the embodiment of the present disclosure, step S200: connecting the master device in series with the plurality of slave devices through the address configuration line, may further include: suspending a second terminal of a last slave device among the plurality of slave devices.

For example, in at least one embodiment of the present disclosure, the plurality of slave devices may be in the address configuration mode or the data transmission mode. In the address configuration mode, the slave device acquires a device address from the master device and writes the device address into the address storage module, to complete address configuration.

For example, in at least one embodiment of the present disclosure, an addresses configuring method of the plurality of slave devices includes: detecting whether an address storage module of a slave device is empty or not; in response to the address storage module of the slave device being empty, the slave device receiving a device address corresponding to the slave device from the master device and storing the device address assigned by the master device into the address storage module; and in response to completing the configuring the device address of the slave device, electrically coupling a second terminal of the slave device to a first terminal of a next adjacent slave device connected in series with the slave device through the address configuration line.

For example, by detecting whether the address storage module of the slave device is empty, or not, it is judged whether address configuration is needed for the slave device, that is, whether the master device needs to assign an initial device address to the slave device through the address configuration line. If the address storage module of the slave device is empty, it is determined that the slave device needs to receive and configure a device address corresponding to the slave device from the master device, for example, store the device address in the address storage module of the slave device. If the address storage module of the slave device is not empty, it is determined that the slave device no longer needs to receive the device address from the master device, for example, the slave device may keep in the data transmission mode, waiting for data transmission with the master device.

For example, in response to completing configuring a device address of a slave device, a second terminal of the slave device may be electrically coupled to a first terminal of a next adjacent slave device connected in series with the slave device through the address configuration line, so as to continue to configure a device address for the next slave device, and so on, until all slave devices have their own device addresses.

For example, the operation of detecting whether the address storage module of the slave device is empty may be set to be performed once after the product is produced, and no longer performed during product use; or may be set to be performed once every time the product is powered on, or performed periodically according to actual requirements (e.g., regularly checking whether the device address of the slave device is correct, or not), or performed automatically or manually according to preset conditions, which will not be limited in the embodiments of the present disclosure.

For example, in at least one embodiment of the present disclosure, an addresses configuring method of a plurality of slave devices includes: detecting a level state of a first terminal of the slave device that is connected with the address configuration line; in response to the first terminal of the slave device that is connected with the address configuration line being boosted, the slave device receiving and configuring the device address corresponding to the slave device from the master device; and in response to completing configuring the device address of the slave device, electrically coupling a second terminal of the slave device to a first terminal of a next adjacent slave device connected in series with the slave device through the address configuration line.

For example, by detecting the level state of the first terminal of the slave device, it is judged whether address configuration is needed for the slave device. For example, if the first terminal of the slave device is boosted, it is determined that the slave device needs to receive and configure the device address corresponding to the slave device from the master device; for example, the device address may be stored in the address storage module of the slave device. If the first terminal of the slave device keeps in a low level state, it is determined that the slave device does not need to receive the device address from the master device. For example, the slave device may keep in the data transmission mode, waiting for data transmission with the master device.

For example, in at least one embodiment of the present disclosure, as shown in FIG. 11, the data transmitting method includes step S500 to step S700.

Step S500: a plurality of slave devices receiving a first data packet from a master device.

Step S600: selecting a target slave device from the plurality of slave devices according to the first data packet.

Step S700: implementing data transmission between the target slave device and the master device according to the first data packet.

For example, in at least one example of the embodiment of the present disclosure, as shown in FIG. 11, the data transmitting method further includes step S100: the master device supplying a clock signal to the plurality of slave devices through a clock signal line.

For example, in at least one example of the embodiment of the present disclosure, a first signal line serves as a first data transmission line. For example, in the example, step S500: a plurality of slave devices receiving a first data packet from a master device, and a specific example including: the plurality of slave devices receiving the first data packet from the master device through the first signal line multiplexed as the first data transmission line.

For example, in the electronic system 10 shown in FIG. 1, the first signal line serves as the first data transmission line; and the plurality of slave devices receive the first data packet from the master device through the first signal line serving as the first data transmission line.

For example, in at least one example of the embodiment of the present disclosure, the electronic system further includes a first data transmission line independent of the first signal line; the plurality of slave devices are connected in parallel with the master device through the first data transmission line independent of the first signal line; the step S500: a plurality of slave devices receiving a first data packet from a master device, and a specific example including: the plurality of slave devices receiving the first data packet from the master device through the first data transmission line.

For example, in the electronic system 20 shown in FIG. 2, the first data transmission line and the first signal line are independent of each other; and the plurality of slave devices receive the first data packet from the master device through the first data transmission line.

For example, in the electronic system 30 shown in FIG. 3, the first data transmission line, the second data transmission line, and the first signal line serving as, for example, an address configuration line, are independent of each other; and the plurality of slave devices may receive the first data packet from the master device through the first data transmission line.

For example, in at least one example of the embodiment of the present disclosure, step S600: selecting a target slave device from the plurality of slave devices according to the first data packet, and a specific example including: acquiring an address bit in the first data packet; judging whether the device address of the slave device matches the address bit, or not; in response to the device address of the slave device matching the address bit, selecting the slave device as a target slave device; and in response to the device address of the slave device not matching the address bit, judging whether a device address of a next adjacent slave device connected in series with the slave device matches the address bit, or not.

For example, the first data packet includes an address bit; the address bit records a device address of the target slave device; each slave device sequentially judges whether the address bit in the first data packet matches its own device address, or not; if it matches, the slave device serves as the target slave device for data transmission with the master device; if it does not match, the slave device continues to transmit the first data packet to a next slave device until the target slave device is found; and then, the target slave device performs data transmission with the master device under control of the clock signal.

For example, in at least one example of the embodiment of the present disclosure, the address configuration operation further includes: the plurality of slave devices receiving a control word from the master device; and implementing data transmission between the target slave device and the master device according to the control word.

For example, the plurality of slave devices may receive the control word from the master device through the first signal line, or may receive the control word from the master device through a second signal line independent of the first signal line, for example, the second signal line may be a first data transmission line.

For example, in the electronic system 10 shown in FIG. 1, the first signal line serves as the first data transmission line; and the plurality of slave devices receive the control word from the master device through the first signal line serving as the first data transmission line.

For example, in the electronic system 20 shown in FIG. 2, the first data transmission line and the first signal line are independent of each other; and the plurality of slave devices receive the control word from the master device through the first data transmission line.

For example, in the electronic system 30 shown in FIG. 3, the first data transmission line, the second data transmission line, and the first signal line serving as, for example, an address configuration line, are independent of each other; and the plurality of slave devices may receive the control word from the master device through the first data transmission line.

For example, in at least one example of the embodiment of the present disclosure, data transmission between the target slave device and the master device is implemented according to the control word, and a specific example thereof may include: selecting a direction of data transmission according to a read/write flag bit in the control word; writing data recorded by the data bit in the first data packet into the target slave device through the first data transmission line, or sending a second data packet acquired from the target slave device to the master device through the first data transmission line.

For example, in the electronic system 10 shown in FIG. 1, the first signal line serves as the first data transmission line; and the target slave device performs data transmission with the master device through the first signal line serving as the first data transmission line. For example, the target slave device may receive data from the master device, for example, write the data recorded by the data bit in the first data packet into the target slave device. For example, the target slave device may send data to the master device, for example, the target slave device sends the second data packet to the master device.

For example, in the electronic system 10 shown in FIG. 2, the target slave device performs data transmission with the master device through the first data transmission line independent of the first signal line. For example, in one example, the target slave device may receive data from the master device through the first data transmission line, for example, write the data recorded by the data bit in the first data packet into the target slave device. For example, in another example, the target slave device may send data to the master device through the first data transmission line, for example, the target slave device sends the second data packet to the master device. For example, in at least one example of the embodiment of the present disclosure, the data transmission between the target slave device and the master device is implemented according to the control word, and a specific example thereof may include: selecting a direction of data transmission according to a read/write flag bit in the control word; writing the data recorded by the data bit in the first data packet into the target slave device through the first data transmission line, or sending the second data packet acquired from the target slave device to the master device through the second data transmission line.

For example, in the electronic system 30 shown in FIG. 3, the first data transmission line, the second data transmission line, and the first signal line serving as, for example, an address configuration line, are independent of each other; and the target slave device performs data transmission with the master device through the first data transmission line and the second data transmission line. For example, the target slave device may receive the data recorded by the data bit in the first data packet from the master device through the first data transmission line; and the target slave device may send the second data packet to the master device through the second data transmission line.

For example, in at least one example of the embodiment of the present disclosure, the implementing data transmission between the target slave device and the master device according to the control word may further include: selecting a length of the transmitted data according to a data length extension bit in the control word; or, selecting a length of the device address according to an address length extension bit in the control word; or, selecting the quantity of target slave devices according to a quantity extension bit of a target slave device in the control word.

The relevant description in the embodiment of the electronic system above may be referred to for the detailed description of the data length extension bit, the address length extension bit, or the quantity extension bit of the target slave device in the control word, which will not be repeated here.

For example, in at least one embodiment of the present disclosure, the data transmitting method further includes: setting a preset time interval for data transmission according to the quantity of the plurality of slave devices.

For example, the data transmitting method may eliminate need for a response mechanism in the electronic system, so as to improve a data transmission speed. For example, the time interval for data transmission may be set according to the quantity of slave devices mounted on the electronic system; for example, the time for a last slave device as a target device in the electronic system to complete data transmission may be used as a minimum time interval, or a preset time interval may be set according to actual needs, and a next data transmission may start at the preset time interval after each data transmission is completed, without waiting for a response signal from the target slave device, which may implement fast data transmission between the master device and the target slave device, for example, the data transmission speed may reach 3 Mbps to 10 Mbps.

For example, in at least one embodiment of the present disclosure, the data transmitting method further includes: controlling data transmission according to the clock signal of the clock signal line; in response to the clock signal being a start clock signal, starting data transmission at a start flag bit corresponding to the start clock signal; and in response to the clock signal being an ending clock signal, ending the data transmission at an ending flag bit corresponding to the ending clock signal.

For example, a start signal is needed before data transmission, as shown in FIG. 12, in an idle state without data transmission, levels on the clock signal line and the data transmission line are both zero. When an operation state of data transmission starts, the clock signal line normally sends the clock signal, and the data transmission line (e.g., the first data transmission line or the second data transmission line according to the present disclosure) boosts on a first falling edge of the clock signal, for example, which is 1, and recovers on a next falling edge of the clock signal, for example, which is 0. That is, when the clock signal is the start clock signal, the data transmission line sends the start signal to the target slave device to start data transmission. For example, a first rising edge of the recovered clock signal is a first data trigger moment; and a first falling edge of the clock signal serves as a data collection position.

For example, when a last data is transmitted, the data transmission line is boosted at a falling edge of the clock signal corresponding to the ending flag bit of data transmission, for example, which is 1, and then is pulled down at a next falling edge of the clock signal, for example, which is 0, to end the data transmission.

In a data transmitting method provided by at least one embodiment of the present disclosure, a device address may be assigned to a slave device through a first signal line, so that addressing may be performed according to the device address of the slave device, and the slave device may be arbitrarily selected and controlled for data transmission with the master device, which improves data transmission efficiency.

At least one embodiment of the present disclosure also provides an electronic apparatus; and the electronic apparatus includes the electronic system according to any embodiment of the present disclosure.

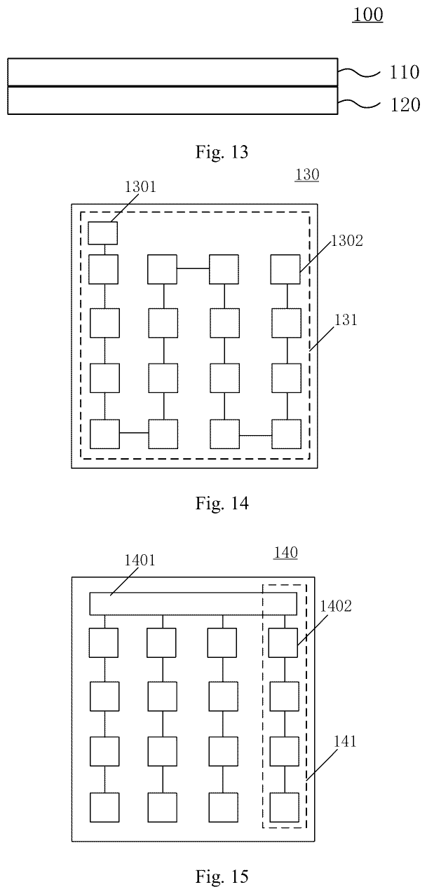

For example, as shown in FIG. 13, the electronic apparatus may be a display apparatus 100; the display apparatus 100 is a liquid crystal display apparatus; the liquid crystal display apparatus includes a liquid crystal panel 110 and a backlight plate 120 provided on a back side of the liquid crystal panel; and the backlight plate 120 includes the above-described electronic system for driving an LED serving as a light-emitting element.

For example, as shown in FIG. 14, the electronic apparatus may also be an LED display apparatus 140, for example, a mini-LED display apparatus or a micro-LED display apparatus; the display apparatus 140 includes the above-described electronic system for driving the LED serving as a light-emitting element, for example, the display apparatus 140 includes a plurality of driver chips (slave devices according to the present disclosure) 1402 of LEDs arranged in an array; a plurality of slave devices 1402 and a master device 1401 constitute an electronic system 141; the master device 1401 is sequentially connected in series with the plurality of slave devices 1402 through a first signal line; and the master device 1401 is connected in parallel with the plurality of slave devices 1402 through a clock signal line (not shown).

For example, the electronic apparatus may also be a touch device, for example, a touch display apparatus, and it includes the above-described electronic system for driving the touch unit.

For example, in the display apparatus provided by at least one embodiment of the present disclosure, one or more electronic systems may be provided; and a wiring pattern of the plurality of slave devices connected in series through the first signal line in the one or more electronic systems may be set according to actual needs, which will not be limited in the embodiments of the present disclosure.

For example, as shown in FIG. 14, a display apparatus 130 includes an electronic system 131; in the electronic system 131, a master device 1301 is sequentially connected in series with a plurality of slave devices 1302 arranged in an array; for example, the plurality of slave devices 1302 may be connected in a snake-liked pattern through a first signal line, and a wiring pattern of the first signal line is snake-liked.

For example, as shown in FIG. 15, the display apparatus 140 includes m rows and n columns of slave devices 1402; m slave devices 1402 on each column and the master device 1401 constitute an electronic system 141, that is, in the example, there may be m electronic systems 141. A plurality of slave devices 1402 in each electronic system 141 are connected in series with the master device 1401 through a first signal line; and a wiring pattern of the first signal line is linear.

In the display apparatus provided by at least one embodiment of the present disclosure, the electronic system may have the first signal line multiplexed as the address configuration line, and high-speed data transmission may be implemented only through the clock signal line and the first signal line serving as the first data transmission line, which may reduce the wirings, reduce layout and wiring difficulties, and save design costs of the display apparatus.

For example, the display apparatus or the touch apparatus may be implemented as a mobile phone, a tablet personal computer, a television, a monitor, a laptop, a digital photo frame, a navigator, etc.

Although the present disclosure has been described in detail above with general descriptions and specific implementation ways, it is apparent to those skilled in the art that some modifications or improvements may be made to the embodiments of the present disclosure. Therefore, these modifications or improvements made without departing from the spirit of the present disclosure are within the scope of the present disclosure.

There are a few points to note about this disclosure:
1) The drawings of the embodiments of the present disclosure only relate to the structures related to the embodiments of the present disclosure, and other structures may refer to a common design.
(2) For the sake of clarity, in the drawings used to describe the embodiments of the present disclosure, the thickness of layers or regions is enlarged or reduced, that is, these drawings are not drawn according to the actual scale.
(3) Without conflicting with each other, the embodiments of the present disclosure and the features therein may be combined with each other to obtain new embodiments.

The above description is only a specific implementation of the present disclosure, but the scope of the present disclosure is not limited thereto. The scope of the present disclosure shall be based on the scope of the claims.

1. An electronic system, comprising a master device, a plurality of slave devices, a clock signal line, and a first signal line,
wherein the master device is connected in parallel with the plurality of slave devices through a same clock signal line to supply a clock signal to the plurality of slave devices;
a first slave device among the plurality of slave devices is connected with the master device through the first signal line; and the plurality of slave devices are sequentially connected in series through the first signal line.

2. The electronic system according to claim 1, wherein the first signal line serves as a first data transmission line,
the first data transmission line is used for data transmission between the master device and the first slave device and among the plurality of slave devices.

3. The electronic system according to claim 1, further comprising: a second signal line independent of the first signal line; wherein the second signal line comprises a first data transmission line; and the plurality of slave devices are connected in parallel with the master device through the first data transmission line independent of the first signal line.

4. The electronic system according to claim 3, wherein the first data transmission line is used for data transmission between the master device and the plurality of slave devices.

5. The electronic system according to claim 3, wherein the second signal line further comprises: a second data transmission line; and the plurality of slave devices are connected in parallel with the master device respectively through the first data transmission line and the second data transmission line.

6. The electronic system according to claim 5, wherein the master device sends data to the plurality of slave devices through the first data transmission line; and the master device receives data from the plurality of slave devices through the second data transmission line.

7. The electronic system according to claim 2, wherein the plurality of slave devices receive a data transmission signal comprising a first data packet from the master device through the first data transmission line, to select a target slave device from the plurality of slave devices for data transmission with the master device according to the first data packet.

8. The electronic system according to claim 7, wherein the first data packet comprises an address bit for selecting a target slave device to perform data transmission with the master device; and a data bit for recording data to be written into the target slave device.

9. (canceled)

10. The electronic system according to claim 2, wherein the plurality of slave devices receive a control word from the master device through the first data transmission line, to determine a data transmission mode between the plurality of slave devices and the master device according to the control word.

11-12. (canceled)

13. The electronic system according to claim 1, wherein the first signal line is an address configuration line;
the plurality of slave devices receive an address configuration signal from the master device through the address configuration line; and the address configuration signal is used for configuring an initial device address for the plurality of slave devices.

14. The electronic system according to claim 2, wherein the first signal line is multiplexed as an address configuration line; the plurality of slave devices receive an address configuration signal from the master device through the address configuration line; and the address configuration signal is used for configuring an initial device address for the plurality of slave devices.

15. The electronic system according to claim 1, wherein a last slave device among the plurality of slave devices is not directly connected with the master device through the first signal line.

16. A slave device for connection with a master device or connection in series with other slave devices, wherein the slave device comprises a clock terminal, a first terminal, a second terminal, and an address storage module,
the clock terminal is connected with the master device through a clock signal line to receive a clock signal from the master device;
the first terminal is connected with the master device through a first signal line, or connected with a second terminal of a previous adjacent slave device connected in series with the slave devices;
the address storage module is configured to store a device address corresponding to the slave device.

17. The slave device according to claim 16, wherein the first signal line serves as the first data transmission line,
the first terminal of the slave device is connected with the master device through the first signal line serving as the first data transmission line, or is connected with the second terminal of the previous adjacent slave device connected in series with the slave devices through the first signal line serving as the first data transmission line.

18. The slave device according to claim 16, further comprising:
a first data terminal configured to be connected with the master device through the first data transmission line; and a second data terminal configured to be connected with the master device through a second data transmission line, wherein the second data transmission line is different from the first data transmission line.

19. (canceled)

20. The slave device according to claim 16, wherein the slave device receives the device address from the master device through the first signal line.

21. The slave device according to claim 16, wherein, after the slave device receives and configures the device address from the master device, the second terminal of the slave device is electrically coupled to a first terminal of a next adjacent slave device connected in series with the slave device through the first signal line, so that the next slave device starts and receives a device address corresponding to the next slave device from the master device.

22. The slave device according to claim 16, further comprising:
a control circuit configured to control the slave device configuring the device address or performing data transmission with the master device.

23-26. (canceled)

27. The slave device according to claim 16, wherein the address storage module comprises a read-only memory.

28-29. (canceled)

30. The slave device according to claim 16, further comprising:
a control terminal configured to be connected with a device to be controlled, wherein the device to be controlled comprises an LED or a touch unit, and the LED comprises at least one of a micro-LED and a mini-LED.

31-48. (canceled)
